(19) United States
(12) Patent Application Publication
(10) Pub. No.: US 2011/0208667 A1
(43) Pub. Date: Aug. 25, 2011

(54) SYSTEM AND METHOD FOR EMISSIONS REDUCTION

(75) Inventors: Patricia Denise Mackenzie, Clifton Park, NY (US); Qing Cao, Albany, NY (US); Joseph James Salvo, Schenectady, NY (US); Roman Brusilovsky, Clifton Park, NY (US); Joseph Edward Jesson, Hamilton Square, NJ (US); Jonathan Steven Muckell, Glenville, NY (US)

(73) Assignee: GENERAL ELECTRIC COMPANY, SCHENECTADY, NY (US)

(21) Appl. No.: 12/711,593

(22) Filed: Feb. 24, 2010

(51) Int. Cl. G06Q 50/00; G01C 21/34; G06Q 10/00

(52) U.S. Cl. 705/336; 701/213; 705/338; 705/341

(57) ABSTRACT

A method for reducing emissions from a plurality of moving assets includes receiving trip pattern data corresponding to positions and times from the moving assets and the preference data from a plurality of users. A database of trips made by the moving assets is then generated based on the trip pattern data and trip consolidation opportunities for the moving assets are identified based on the generated database. The method also includes ranking the trip consolidation opportunities based on the preference data and utilizing the ranked trip consolidation opportunities to provide shipping recommendations designed to reduce fuel consumption of the moving assets.

### BACKGROUND

The invention relates generally to cargo vehicle emissions reduction and more specifically, to emissions reduction using intelligent automated decision-making.

Cargo shipping is one of the primary causes of emissions and as such contributes significantly to the pollution of our environment. Emissions from cargo shipping include, for example, sulfur dioxide (SO₂) and nitrogen oxide (NOₓ).

When vehicles or tractor-trailers are moved with little or no cargo, wasteful emissions occur. Analysis of inter-fleet data shows many lost opportunities for trip consolidation such as identifying backhauling loads i.e. cargo that may have been moved by an otherwise empty trailer on a return trip from a delivery point to a home base.

Recently there has been an increasing interest in collaborative logistics in the freight transportation industry. Typically, shippers and carriers have managed operations independently. A new trend emerging is to collaborate to identify potential opportunities on a system level and share the benefits of integrated operation costs among partners.

Brokerage systems that facilitate matching of load sharing and backhaul opportunities currently do not incorporate monitoring and analysis of real-time geo-based information from all brokerage participants. Currently, transportation brokerage systems match loads to participating partners either through individual driver's use of kiosks located at various stops of vehicles or through other brokerage services. Lack of automation results in vehicles pulling empty/partial cargo despite a potential for collaborations.

Therefore, there is a need for an improved, automated collaborative transportation system to address one or more aforementioned issues.

### BRIEF DESCRIPTION

In accordance with an embodiment of the present invention, a method for reducing emissions from a plurality of moving assets is provided. The method includes receiving trip pattern data corresponding to positions and times from the moving assets and receiving preference data from a plurality of users. The method further includes generating a database of trips made by the moving assets based on the trip pattern data and identifying trip consolidation opportunities for the moving assets based on the generated database. The method also includes ranking the trip consolidation opportunities based on the preference data and utilizing the ranked trip consolidation opportunities to provide shipping recommendations designed to reduce fuel consumption of the moving assets.

In accordance with another embodiment of the present invention an emissions reduction system comprising a data collection unit, a trip database generation module, a trip consolidation opportunities identification module, a trip ranking module and a communication network is provided. The data collection unit receives trip pattern data for a plurality of cargo vehicles and user preference data. The trip database generation module generates a cargo vehicle trip database based on the trip pattern data, and the trip consolidation opportunities identification module identifies trip consolidation opportunities based on the cargo vehicle trip database. The trip ranking module further ranks the trip consolidation opportunities based on the preference data, and the communication network provides at least one user with shipping recommendations based on the ranked trip consolidation opportunities. The system is designed to reduce fuel consumption of the moving assets.

In accordance with yet another embodiment of the present invention, a method for reducing emissions from a plurality of moving assets is provided. The method includes receiving trip pattern data corresponding to positions and times from the moving assets and generating a database of trips made by the moving assets based on the trip pattern data. The method also includes identifying trip consolidation opportunities for the moving assets based on the generated database and ranking the trip consolidation opportunities. The method further includes utilizing the ranked trip consolidation opportunities to provide shipping recommendations designed to reduce fuel consumption of the moving assets.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic illustration of a trailer system with a simplified communication system in accordance with an embodiment of the present invention;

FIG. 2 is an exemplary embodiment of a collaborative transportation system in accordance with an embodiment of the present invention;

FIG. 3 is a schematic representation of an emissions reduction system in accordance with an embodiment of the present invention;

FIG. 4 is a schematic illustration for calculating an actual route traveled by a cargo vehicle; and

FIG. 5 is a schematic representation of an exemplary empty trip from Virginia/North Carolina border in order to identify a trip consolidation opportunity in accordance with an embodiment of the invention.

### DETAILED DESCRIPTION

As discussed in detail below, embodiments of the invention include a system and method for moving assets emissions reduction. The system and method provide an algorithm for near real time detection and utilization of trip consolidation opportunities in collaborative transportation systems, thereby reducing moving assets' trips and thus, wasteful emissions.

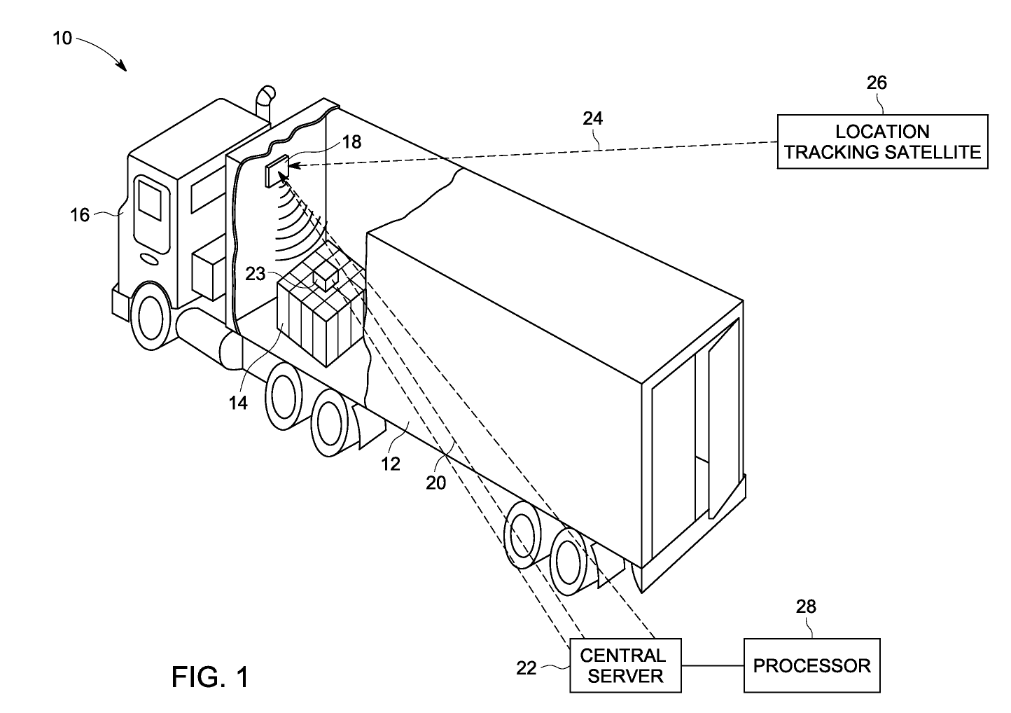

FIG. 1 is a schematic illustration of a trailer system 10 with a simplified communication system. The system 10 includes a trailer 12 for carrying goods 14 and a cab 16 attached to a front end of the trailer 12. A remote hub 18 is located in the trailer 12 and configured to transmit wireless signals 20 to a central server 22. The remote hub 18 may also receive wireless signals 24 about location information via a location tracking satellite 26. The wireless signals 20 may be transmitted by techniques such as cellular, satellite or WiFi communication, for example. The location tracking satellite 26 may comprise, for example, a global positioning satellite (GPS). In another embodiment, the location information may be provided by a non-satellite source such as a cellular tower or other fixed wireless nodes. The remote hub 18 may further transmit wireless signals to the cab 16 to relay information received via the wireless signals 20 and 24 respectively. One example of such a remote hub 18 is a VeriWise™ hub, produced by the General Electric Company. The central server 22 is coupled to a processor 28 configured to identify trip consolidation opportunities. Other users (not shown) such as shippers, receivers, brokers and drivers may also be connected to the server to form a collaborative transportation system.

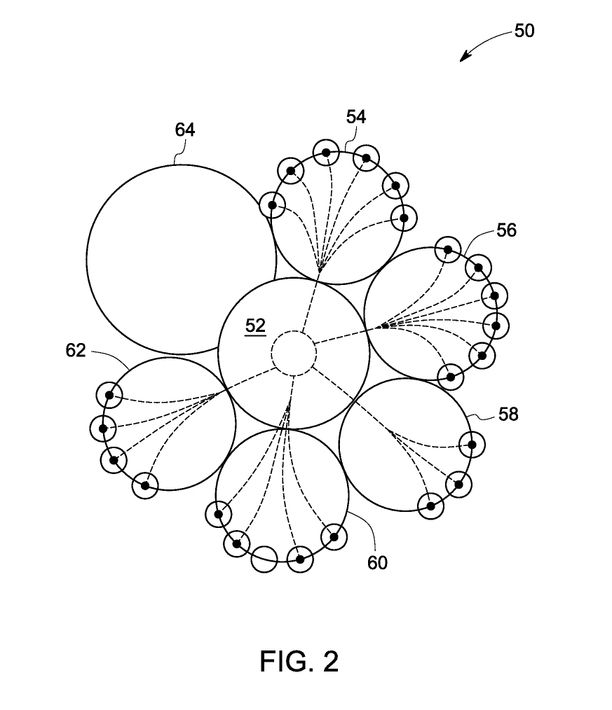

FIG. 2 shows an exemplary embodiment of a collaborative transportation system 50. The transportation system 50 includes a server 52, which may serve as a central feature of the transportation system 50 as each of the users in the transportation system 50 may provide data to and receive data from the server 52. The users in the transportation system 50 may include a shipper 54, a receiver 56, a load 58, a driver or carrier 60, and a broker 62. Although each user is depicted in FIG. 2 as a single entity, the shipper 54, the receiver 56, the load 58, the driver or carrier 60, and the broker 62 may, in fact, include a plurality of individual users (that is, shippers 54, receivers 56, loads 58, drivers or carriers 60, or brokers 62). Additionally, the transportation system 50 may include a data collection system 64. Users in the collaborative transportation system 50 may communicate with the server 52 via any electronic device with one example comprising a kiosk located in a truck stop. Alternatively, the user may use a cell phone or a computer or any electronic device enabled to access the Internet.

In one embodiment, the data collection system 64 comprises a remote hub 18 (FIG. 1) and a communication network (not shown). Automated inputs from the data collection system 64 may include, for example, status data from multiple vehicles 12 (FIG. 1) such as “trip start” or “trip end” status and event status from multiple vehicles such as, “door open,” “door close,” “cargo loaded,” “cargo empty,” “cargo vehicle weighing capacity,” etc. In one embodiment, inputs from the data collection system are used to identify trip consolidation opportunities. For example, if it is determined that a cargo vehicle A on route X is returning back empty and a load L from another shipper on the same route is to be picked up, then the server 52 may provide a real time signal to the vehicle A to pick up the load L on its return trip. Thus, load L does not need a separate cargo vehicle and an extra trip of a cargo vehicle can be avoided with the result being a reduction in emissions. In another example of an emission reduction, when a cargo vehicle is being transported to a new location to pick up a load, the system can be used to determine whether there are any loads needing transport in the vicinity of that new location. In yet another example, the server 52 may provide a signal to a shipper to inform the shipper about carriers that are currently located near the shipper with empty trailers.

In certain embodiments, the load 58 may provide data to the server 52, such as the load weight, temperature, and mishandling information, based on signals from sensors 23 (FIG. 1), such as thermometers and accelerometers, located on or near the load 18. In such systems, the load 58 may be provided with a radio frequency identification (RFID) tag that contains information related to the shipping of the load 58. For example, the RFID tag may indicate temperature constraints and handling instructions. Alternatively, a shipper 54 or receiver 56 may provide handling instructions to the server 52 on behalf of the load 58. In one embodiment, the data relating to the load 58 may be used to determine trip consolidation opportunities. For example, if it is identified that two small loads from two different shippers are to be shipped on the same route and they have similar temperature constraints or handling instructions, then they may be combined into one single load and shipped in a common cargo vehicle resulting into emissions reduction by saving a cargo trip.

The collaborative transportation system 50 may be configured to manage preferences and personal profiles for each of the users. The management of preferences and personal profiles of users is essential to ensure that the user constraints are met while utilizing trip consolidation opportunities. For example, a personal profile for the driver 60 may contain basic facts such as years of experience, license type, average load value, customer feedback, ratings, reliability, references, and credentials. Additionally, the driver's personal profile may include preferences such as preferred trip distance, preferred hours of driving, and preferred load types. Some of the details may be provided by the driver 60, while other details, such as average load value, may be computed by the server 52 over a period of time. The shipper 54, on the other hand, may complete a profile that contains basic facts such as shipper's location and hours of operation, and preferences such as preferred load handling practices, and/or preferred hours of load pick up. A receiver 56 may complete a profile that may contain similar facts, and may also include the number of loading docks at the facility, and preferences such as the use of certain loading docks for different loads for different shippers, and preferred delivery schedule.

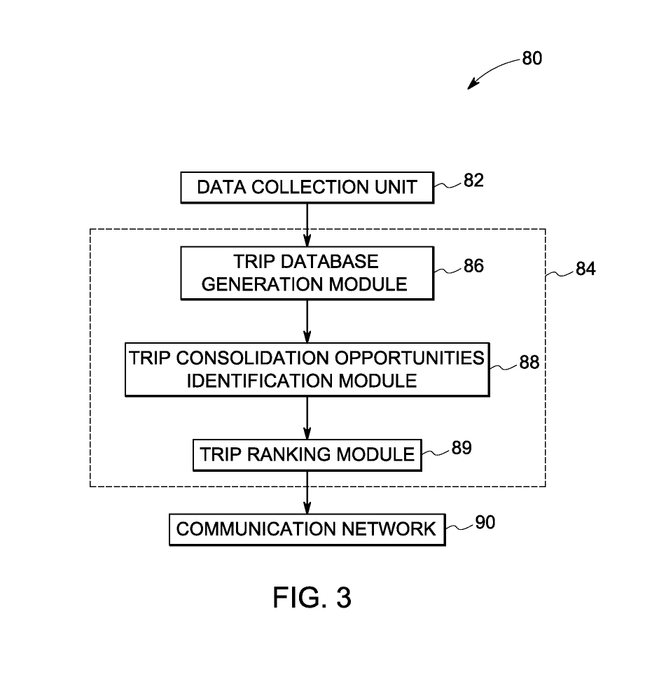

FIG. 3 is a schematic illustration of one embodiment of an emissions reduction system 80. The system 80 includes a data collection unit 82, a server 84 comprising a trailer trip database generation module 86, a trip consolidation opportunities identification module 88, a trip ranking module 89 and a communication network 90. In one embodiment, the data collection unit 82 may comprise a wireless transmitter device, configured to obtain trip pattern data related to a truck, a trailer, or other load. In one embodiment, the data collection unit may comprise a GPS receiver.

In another embodiment, trip pattern data collected may include the temperature of a trailer and/or the load and load vibration and impact event data. Additionally, the data collection unit may be configured with location-indicating capabilities. Thus, the data collection unit may indicate current location, time, and a transportation route as well as deviation from a negotiated transportation route. The data collection unit may operate as a satellite-based system, a wireless Internet system, a radio frequency (RF) system, or any other suitable communication system. The data collection unit further comprises a data collection device to obtain preference data from various users such as shippers, brokers, receivers, and drivers. The preference data as described earlier may comprise preferred trip distance, preferred load types of a driver or preferred load handling practices, preferred shipper cost and/or preferred hours of load pick up for a shipper, for example.

The trip database generation module 86 processes the data gathered from the data collection unit 86 and generates a database of trips made by various cargo vehicles. In one embodiment, the trip database generation module receives position or location, time and status or messages such as “trip start” or “trip end” of cargo vehicles from the remote hub 18 (FIG. 1). In order to generate or extract trips made by vehicles, the trips are represented by message sequences between consecutive “trip start” events and “trip end” events. “Intermediate” statuses or messages between “trip start” and “trip end” may also be processed by the trip database generation module. Locations of the intermediate messages provide additional information about a trip and can be useful to differentiate trips with different routes.

The trip consolidation opportunities identification module 88 identifies trip consolidation opportunities based on the generated trip database and the preference data. The trip consolidation opportunities may comprise opportunities such as backhaul opportunities, combining multiple smaller loads into fewer larger loads, and shipping a load when a vehicle is being moved to a new location for receiving a load. Combining multiple smaller loads into fewer larger loads on a common route saves number of vehicle trips needed to ship those loads and thereby results in reduced trips and reduced emission. The trip consolidation opportunities may further comprise determining a nearest shipper with empty or not fully loaded cargo for a given load. Thus, the trip consolidation opportunities optimize the movement of cargo vehicles, reduce their fuel consumption, and help in reducing emissions.

The preference data is used for comparative valuations of cargo vehicle trip consolidation opportunities. In one embodiment, a valuation matrix that reflects the immediate preferences of each of the users may be maintained by the emissions reduction system 80 and may be used in a comparative evaluation process. The preference information or preference data may be added to the data collection unit 82 either automatically (e.g., by tracking a user's behavior), or manually input by a user into a custom interface of the emissions reduction system 80 or through a general user interface such as a web browser, for example.

In the valuation matrix, preferences are weighted and the score of a given trip consolidation opportunity is valued based on that weighting. Preferences to be weighted can include any of the factors in the system including, but not limited to, driver qualifications (such as license type, on-time performance, and language), shipper qualifications (such as timeliness of payments and ease of working relationships), shipper needs (such as on time delivery), as well as other similar factors related to carriers and loads. A summation across all preferences may then enable the system to compare trip consolidation opportunities. The weightings may be either user-entered or learned. A “learned” weighting is created by determining what the user has previously selected as choices and/or which choices have brought benefit to the user. The manual weightings that go into the valuation matrix may be dynamic and may be changed to meet any short-term need. For example, a shipper may weight “reliability of delivery” higher and “on-time delivery” lower. Therefore, an opportunity requiring that a load absolutely be delivered, with less emphasis on timing, will be scored higher. Similar examples may be generated for the carrier or the load itself. The valuation matrix may encompass all of the user interactions. Therefore, the suitability of the carrier for a given load may be evaluated (e.g., how well the carrier meets the requirements of the load) and vice versa (e.g., how suitable is the load for the carrier and how much emission reduction may be achieved by the carrier by carrying this load). All of the interactions may have this two-way element and all such interactions may thus be included in the valuation matrix. The net result is the score or rank given to the potential trip consolidation opportunity by the trip ranking module 89.

Once a trip consolidation opportunity is identified, the server 84 communicates it to the respective user via communication network 90. For example, the server may send a real time signal to a shipper or a driver to pick up a load from a particular location during its return empty journey. In one embodiment, the server may send a signal to a driver who is heading to a new location to pick up some load to deliver a different load during its journey towards a new location. In another embodiment, the server may send a signal to a driver to consolidate certain loads in a given area and ship those loads as a single load instead of asking multiple vehicles to go and pick the various loads in that area. In yet another embodiment, the server may send a signal to other users such as a shipper or a broker and then the shipper or the broker communicates the signal to the respective driver to utilize the trip consolidation opportunity.

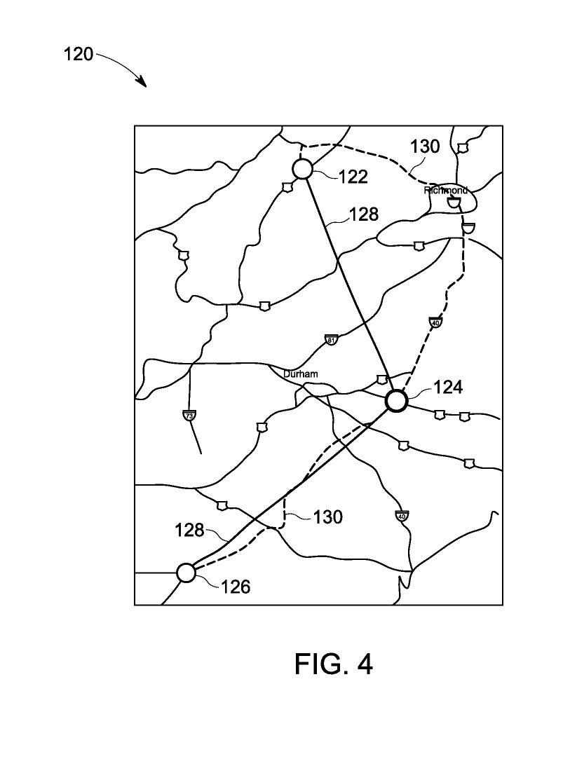

FIG. 4 is a schematic illustration 120 for calculating an actual route traveled by the vehicle 12 (FIG. 1). Frequent cargo trip data exists as a series of line segments connecting different time based, geo-referenced messages received from a device such as, a remote hub 18 (FIG. 1). An ordered series of three geo-coded messages received corresponding to three locations denoted by reference numerals 122, 124, 126 respectively is observed. A straight-line distance between the three locations is denoted by 128, while an estimated route between the three locations is denoted by 130. In practice, the straight-line distance 128 between locations 122 and 124 is known to be very inaccurate since there are no major highways within a reasonable distance of the line 128. Restriction of large vehicles, such as, but not limited to, trucks, to major roadways further reduces domain of possible routes traveled. The line 130 is a likely estimation of the actual route.

To calculate the actual route, a geometric network may be constructed using software that allows for calculating routes and modeling the historical flow of monitored resources throughout a roadway network. In an exemplary embodiment, an ArcGIS software is employed. Routes are weighted based on the cost or estimated travel-time to traverse each edge. The route with the minimal traversal time is often, but not always, considered the most likely traversed route. Additional information determined from analysis of telematics data can help validate the accuracy of the predicted route. The reasonableness of a proposed route is determined by comparing the estimated travel time to the actually observed duration. In another embodiment, to further improve accuracy, intermediate messages are analyzed. These are event-based messages beyond start/end of trip information, such as “door open”, or “cargo loaded.” Since each frequent trip is comprised of a set of individual trips, the in-transit messages from each trip assists in determining the frequently traversed routes. The frequent routes thus derived are used to create a model of historical freight movement.

In order to generate a model for historical vehicle movement, variables need to be associated with appropriate geographical locations and routes. Exemplary variables include cargo status and frequency information. It should be noted that other variables related to temporal information such as extent of time collaboration or load sharing that may occur also may be employed. Furthermore, locations of distribution centers where trucks may be physically loaded and unloaded may be useful. As used herein, cargo status is defined as the ratio of full trips to total trips, and is recorded as a Boolean, specifically, 1=cargo_status, 0=empty cargo_status. A value of 0 indicates that vehicles that traveled along that route were empty. Similarly, if cargo_status=1, then all the vehicles traveled full. A mean cargo_status of 0.5 would indicate half of the vehicles traveling that route as empty and half were full. Knowledge of cargo status is useful in assessing backhaul opportunities i.e. matching between empty trips and full trips occurring in the same direction. A similar process occurs for route frequency, except that the frequency for each route is initialized based on number of trips clustered together. The frequency of these trips weights a backhaul opportunity in determining likelihood that a collaborative match may occur within temporal restraints. In the model, each road segment is embedded with cargo status and frequency information for each direction of travel. To determine cargo status and frequency at specific route segments, routes that overlap may be combined.

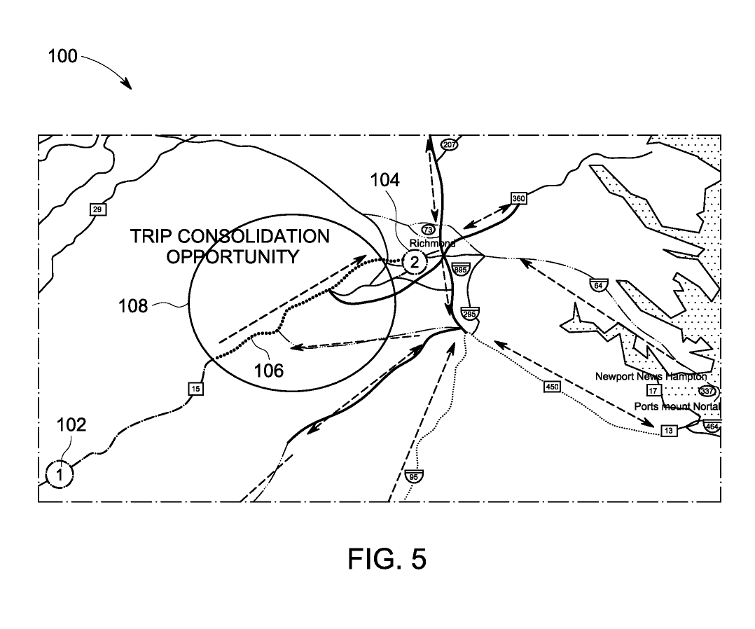

FIG. 5 is a schematic representation of an exemplary empty trip 100 from Virginia/North Carolina border represented by reference numeral 102 towards Richmond, 104 in order to identify a trip consolidation opportunity. The trip 100 indicates a vehicle travelling with an empty or not fully loaded trailer. The vehicle may be returning to a distribution center after delivering a primary shipment or may be heading to receive a load. The trip overlaps with a highly traveled route in the same direction about halfway towards Richmond, as indicated by reference numeral 106. Since both the frequency of trips and percentage of full loads are high, there are very significant opportunities to consolidate the trips. Region 108 indicates where trip consolidation could occur. The viability of an opportunity is determined by a frequency and average cargo status at the intersection of the empty trip and the historical freight network, wherein the historical freight network is determined based on historical data of multiple cargo vehicle trips. In one trip consolidation opportunity, the empty trailer may find a load on the heavily travelled route 106, pick it up halfway, and deliver it to the destination on the same route.

The trip consolidation opportunities are then ranked based on the preference data using a valuation matrix as described earlier. For example travel time and network constraints may affect the ranking of an opportunity. In an example, a high variance in travel time correlates to higher risk of delivering shipment on time. In another example, avoiding traveling in a certain area due to environmental or safety constraints correlates to higher risk.

The various embodiments of systems and methods to identify trip consolidation opportunities described above thus provide near real-time automated detection by using a large telematics network tracking potentially hundreds of thousands of assets. The system and method facilitate automated business partner discovery and multi-hop schedule recommendations. The technique benefits smaller fleets as well as larger fleets and improves freight transit efficiency, thus reducing number of vehicles traveling with empty cargo or with half loaded cargo. This further reduces amount of CO2 and NOx emissions produced by the vehicles. By identifying trip consolidation opportunities, a number of empty miles can be reduced, saving money on fuel, salary and vehicle costs in addition to reducing emissions.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method of reducing emissions from a plurality of moving assets, the method comprising
receiving trip pattern data corresponding to positions and times from the moving assets;
receiving preference data from a plurality of users;
generating a database of trips made by the moving assets based on the trip pattern data;
identifying trip consolidation opportunities for the moving assets based on the generated database;
ranking the trip consolidation opportunities based on the preference data; and
utilizing the ranked trip consolidation opportunities to provide shipping recommendations designed to reduce fuel consumption of the moving assets.

2. The method of claim 1, wherein users comprise at least two of a shipper, a receiver, a load, a driver, or a broker.

3. The method of claim 1, wherein the trip pattern data further comprises status data.

4. The method of claim 3, wherein the status data comprises a “trip start” or a “trip end” status.

5. The method of claim 4, wherein the trip pattern data further comprises “intermediate” status.

6. The method of claim 1, wherein the trip pattern data further comprises event data.

7. The method of claim 6, wherein the event data comprises a “door open”, a “door closed”, “cargo loaded”, or a “cargo empty” event.

8. The method of claim 1, wherein the trip pattern data comprises load weight data, load temperature data, or load mishandling data.

9. The method of claim 1, wherein the preference data comprises at least one of a preferred trip distance, a preferred load type, a preferred load handling practice, a preferred shipper cost, preferred hours of driving, preferred loading docks for preferred loads, preferred number of loading docks, preferred delivery schedule or preferred hours of load pick up.

10. The method of claim 1, wherein trip consolidation opportunities comprise backhaul opportunities.

11. The method of claim 1, wherein trip consolidation opportunities comprise opportunities for combining multiple smaller loads.

12. The method of claim 1, wherein trip consolidation opportunities comprise opportunities for delivering a load when the moving asset is being moved to a new location for receiving a different load.

13. The method of claim 1, wherein trip consolidation opportunities comprise opportunities of a nearest shipper for a load.

14. The method of claim 1, wherein ranking the trip consolidation opportunities comprises comparative valuation of trip consolidation opportunities based on a valuation matrix.

15. The method of claim 14, wherein the valuation matrix comprises a matrix wherein each trip consolidation opportunity is given a score by weighing each preference in the preference data.

16. The method of claim 1, wherein generating the database comprises determining the route travelled by multiple vehicles by constructing a geometric network.

17. The method of claim 1, wherein utilizing the ranked trip consolidation opportunities comprises communicating the ranked trip consolidation opportunities to a plurality of users.

18. An emissions reduction system, comprising:
a data collection unit for receiving trip pattern data for a plurality of cargo vehicles and user preference data;
a trip database generation module for generating a cargo vehicle trip database based on the trip pattern data;
a trip consolidation opportunities identification module for identifying trip consolidation opportunities based on the cargo vehicle trip database;
a trip ranking module for ranking the trip consolidation opportunities based on the preference data; and
a communication network for providing at least one user with shipping recommendations based on the ranked trip consolidation opportunities and designed to reduce fuel consumption of the moving assets.

19. The system of claim 18, wherein the data collection unit comprises a GPS data receiver.

20. A method of reducing emissions from a plurality of moving assets, the method comprising
receiving trip pattern data corresponding to positions and times from the moving assets;
generating a database of trips made by the moving assets based on the trip pattern data;
identifying trip consolidation opportunities for the moving assets based on the generated database;
ranking the trip consolidation opportunities; and
utilizing the ranked trip consolidation opportunities to provide shipping recommendations designed to reduce fuel consumption of the moving assets.
